(19) United States
(12) Patent Application Publication
(10) Pub. No.: US 2013/0260726 A1
(43) Pub. Date: Oct. 3, 2013

(54) QUEUE REMINDER SYSTEM AND QUEUE REMINDER METHOD

(71) Applicants: HONG FU JIN PRECISION INDUSTRY (SHENZHE, Shenzhen City (CN); HON HAI PRECISION INDUSTRY CO., LTD., Tu-Cheng (TW)

(72) Inventors: ZHENG-QUAN PENG, Shenzhen City (CN); ZHAO-YANG CAI, Shenzhen City (CN); JIA-QING HUANG, Shenzhen City (CN); YI-XIN TU, Shenzhen City (CN); HAI-QING ZHOU, Shenzhen City (CN)

(73) Assignees: HON HAI PRECISION INDUSTRY CO., LTD., Tu-Cheng (TW); HONG FU JIN PRECISION INDUSTRY (ShenZhen)CO. LTD., Shenzhen City (CN)

(21) Appl. No.: 13/626,855

(22) Filed: Sep. 25, 2012

(30) Foreign Application Priority Data
Mar. 29, 2012 (CN) 201210087696.7

(51) Int. Cl. H04W 4/16

(52) U.S. Cl. 455/414.1

(57) ABSTRACT

A queue reminder method applied in a computing device computes a predicted waiting time interval of each uncalled number. The method generates a message when the predicted waiting time interval of an uncalled number is less than a preset time interval, and sends the message to a communication account associated with the uncalled number.

### BACKGROUND

1. Technical Field

The present disclosure relates to queue management systems, and particularly, to a queue reminder system and a method for the queue reminder system.

2. Description of Related Art

In an existing queue management system, users have to stay put and wait for their numbers to be called. This can be inconvenient and time-consuming. Thus, a new queue management system is desired.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of a computing device with queue reminder function, in accordance with an exemplary embodiment.

FIG. 2 is a block diagram of a queue reminder system, in accordance with an exemplary embodiment.

FIG. 3 is a flowchart of a queue reminder method, in accordance with an exemplary embodiment.

### DETAILED DESCRIPTION

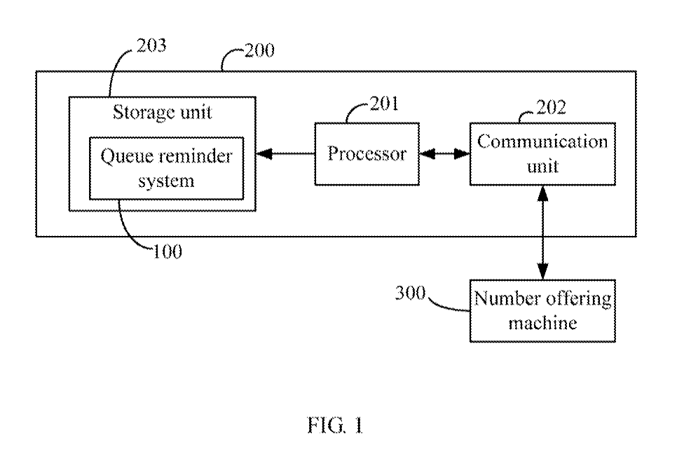

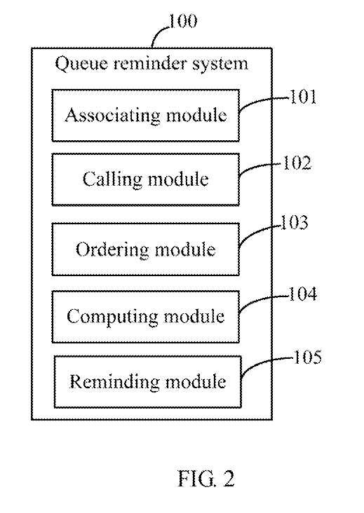

Referring to FIG. 1 and FIG. 2, a queue reminder system 100 applied in a computing device 200 is illustrated. The computing device 200 includes a processor 201, a communication unit 202, and a storage unit 203. The communication unit 202 communicates the computing device 200 with a number offering machine 300. When a visitor takes a number, the number offering machine 300 prompts the customer to input a communication account. The communication account may be a phone number of a mobile phone, an MSN, or the like. The system 100 includes an associating module 101, a calling module 102, an ordering module 103, a computing module 104, and a reminding module 105, which are stored in the storage unit 203 and executed by the processor 201 to perform functions of the system 100.

The associating module 101 is operable to associate each number offered by the number offering machine 300 with a communication account.

The calling module 102 is operable to call a number when the number's turn is up, and record the beginning time of the call.

The ordering module 103 is operable to generate a waiting sequence list according to the sequence of the number offered by the number offering machine 300, and update the waiting sequence list when a call is finished. The waiting sequence list records the uncalled number in sequence. When a number is called, the ordering module 103 is operable to remove the called number from the waiting sequence list and correspondingly adjust the waiting sequence of the uncalled number.

The computing module 104 is operable to compute each time interval between each two sequential calls according to the beginning time of each call, compute an average time interval according to each time interval, and compute a predicted waiting time interval of each uncalled number according to the sequence in the waiting sequence list and the average time interval. In detail, if the sequence of a number N1 in the waiting sequence list is N, and the average time interval is T, the computing module 104 is operable to determine that the predicted waiting time interval of the number N1 is (N−1)×T.

The reminding module 105 is operable to generate a message if the predicted waiting time interval of an uncalled number is less than a preset time interval, and send the message to the communication account associated with the uncalled number to remind that the turn of the uncalled number is up.

In an alternative embodiment, the number offering machine 300 can prompt a visitor to input a predicted returning time when taking a number. The computing module 104 is operable to compute a predicted beginning time of a call of an uncalled number according to the predicted waiting time interval and the current time. The reminding module 105 is operable to generate and send a message if the predicted beginning time is ahead of the predicted returning time.

With such configuration, the visitor is free to attend to other businesses without losing the spot in the queue. When it is the visitor's turn, a message is sent to remind the visitor, thereby saving the visitor's time.

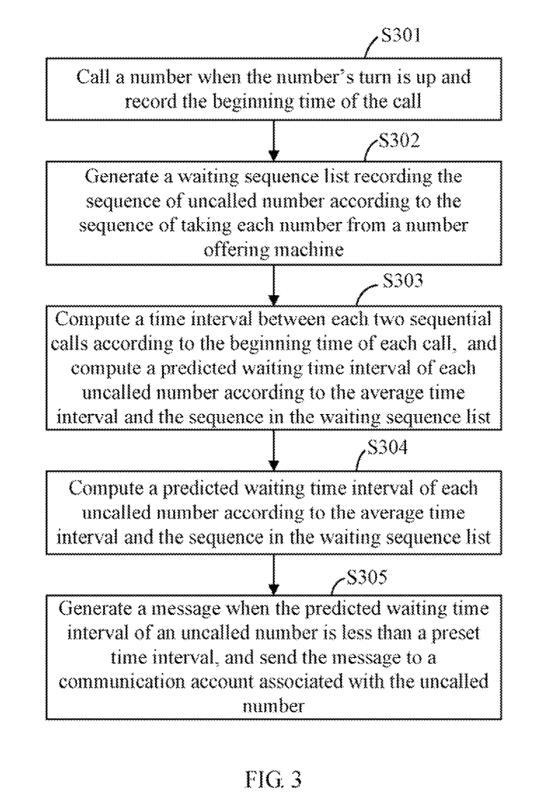

Referring to FIG. 3, in step S301, the associating module 101 is operable to associate each number offered by the number offering machine 300 with a communication account.

In step S302, the calling module 102 is operable to call a number when the number's turn is up and record the beginning time of the call.

In step S303, the ordering module 103 is operable to generate a waiting sequence list recording the sequence of uncalled number according to the sequence of taking each number from the number offering machine 300.

In step S304, the computing module 104 is operable to compute a time interval between each two sequential calls according to the beginning time of each call, and compute a predicted waiting time interval of each uncalled number according to the average time interval and the sequence in the waiting sequence list.

In step S305, the computing module 104 is operable to compute a predicted waiting time interval of each uncalled number according to the average time interval and the sequence in the waiting sequence list.

In step S306, the reminding module 105 is operable to generate a message when the predicted waiting time interval of an uncalled number is less than a preset time interval, and send the message to the communication account associated with the uncalled number.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A queue reminding method applied in a computing device, the computing device communicating with a number offering machine, the method comprising:
associating each of a plurality of numbers offered by the number offering machine with a communication account input through the number offering machine;
calling a number when the number's turn is up;
recording a beginning time of each call for the called ones of the numbers;
generating a waiting sequence list recording the sequence of uncalled ones of the numbers according to a sequence of each uncalled number offered from the number offering machine;
computing a time interval between each two sequential calls according to the beginning time of each of the sequential calls;
computing an average time interval according to each time interval;
computing a predicted waiting time interval of each uncalled number according to the average time interval and the sequence in the waiting sequence list; and
generating a message when the predicted waiting time interval of an uncalled number is less than a preset time interval, and sending the message to the communication account associated with the uncalled number.

2. The method as described in claim 1, further comprising:
associating each of the plurality of numbers offered by the number offering machine with a predicted returning time input through the number offering machine;
computing a predicted beginning time of each call of each uncalled number according to the predicted waiting time interval of each uncalled number and the current time; and
generating the message if the predicted beginning time of a call of an uncalled number is ahead of the predicted returning time of the uncalled number, and sending the message to the communication account associated with the uncalled number.

3. A computing device, comprising:
a communication unit to communicate the computing device with a number offering machine;
a storage unit storing a plurality of modules; and
a processor to execute the plurality of modules;
wherein the plurality of modules comprises instructions executable by the processor to:
associate each of a plurality of numbers offered by the number offering machine with a communication account input through the number offering machine;
call a number when the number's turn is up;
record a beginning time of each call for the called ones of the numbers;
generate a waiting sequence list recording the sequence of uncalled ones of the numbers according to a sequence of each uncalled number from the number offering machine;
compute a time interval between each two sequential calls according to the beginning time of each of the sequential calls;
compute an average time interval according to each time interval;
compute a predicted waiting time interval of each uncalled number according to the average time interval and the sequence in the waiting sequence list; and
generate a message when the predicted waiting time interval of an uncalled number is less than a preset time interval, and sending the message to the communication account associated with the uncalled number.

4. The computing device as described in claim 3, wherein the plurality of modules further comprises instructions executable by the processor to:
associate each number offered by the number offering machine with a predicted returning time input through the number offering machine;
compute a predicted beginning time of each call of each uncalled number according to the predicted waiting time interval of the uncalled number and the current time; and
generate the message if the predicted beginning time of a call of an uncalled number is ahead of the predicted returning time of the uncalled number, and sending the message to the communication account associated with the uncalled number.

5. A storage medium storing a plurality of modules, the plurality of modules comprising instructions executable by a processor of a computing device to perform a queue reminder method, the method comprising:
associating each of a plurality of numbers offered by the number offering machine with a communication account input through the number offering machine;
calling a number when the number's turn is up;
recording a beginning time of each call for the called ones of the numbers;
generating a waiting sequence list recording the sequence of uncalled ones of the numbers according to a sequence of each uncalled number from the number offering machine;
computing a time interval between each two sequential calls according to the beginning time of each of the sequential calls;
computing an average time interval according to each time interval;
computing a predicted waiting time interval of each uncalled number according to the average time interval and the sequence in the waiting sequence list; and
generating a message when the predicted waiting time interval of an uncalled number is less than a preset time interval, and sending the message to the communication account associated with the uncalled number.

6. The storage medium as described in claim 5, wherein the method further comprises:
associating each number offered by the number offering machine with a predicted returning time input through the number offering machine;
computing a predicted beginning time of a call of an uncalled number according to the predicted waiting time interval of the uncalled number and the current time; and
generating the message if the predicted beginning time of a call of an uncalled number is ahead of the predicted returning time of the uncalled number, and sending the message to the communication account associated with the uncalled number.
